(19) United States
(12) Patent Application Publication
(10) Pub. No.: US 2017/0032001 A1
(43) Pub. Date: Feb. 2, 2017

(54) A COMPUTING DEVICE FOR RELATING NODES AND ITEMS IN SOCIAL GRAPH

(71) Applicant: MAGICAL GROUP PTY LTD, Kings Langley (AU)

(72) Inventors: Anthony Kyle AMADIO, New South Wales (AU); Emmanuel CARYDIS, Beverly Hills (AU); Viveka William Jacob WEILEY, Leichhardt (AU)

(21) Appl. No.: 15/106,890

(22) PCT Filed: Dec. 23, 2014
(86) PCT No.: PCT/AU2014/001159

§ 371 Date: Jun. 21, 2016

(30) Foreign Application Priority Data
Dec. 23, 2013 (AU) 2013905036

(51) Int. Cl. G06F 17/30; G06F 3/0486; G06Q 30/02

(52) U.S. Cl. CPC G06F 17/30557; G06Q 30/02; G06F 3/0486; G06Q 50/01

(57) ABSTRACT

A social gift-giving system is operable with a social networking service such as Facebook. A graphical user interface (GUI) is provided on a display of a computing device. A user logs in to the social networking service. Responsive to selection of a first region of the GUI, the GUI displays a list of other users of the social networking service associated with the first user. These other users may be the first user's Facebook friends. Using the GUI, the user can select a Facebook friend, select a gift for the friend, and purchase the gift for the friend.

### FIELD OF THE INVENTION

The present invention relates to e-commerce and social platforms and in particular to a computing device for relating nodes and items in social graph.

### BACKGROUND

Existing online platforms comprise social platform such as Facebook™ and the like and e-commerce platforms such as Amazon™.

The social platforms allow users to maintain a social profile including in creating relations with other nodes (i.e. “friends”) within a social graph. Furthermore, these e-commerce platforms allow for the review and purchase of various items.

However, these platforms are isolated offerings today and a need therefore exists for a system for relating nodes and items in a social graph.

It is to be understood that, if any prior art information is referred to herein, such reference does not constitute an admission that the information forms part of the common general knowledge in the art, in Australia or any other country.

### SUMMARY

Disclosed here are systems and methods for management of social interactions and connections between members of a social network or community.

The invention disclose herein seeks to provide a computing device relating nodes and items in a social graph which will overcome or substantially ameliorate at least some of the deficiencies of the prior art, or at least provide a useful alternative.

According to one aspect, there is provided a computing device for relating nodes and items in a social graph. The computing device comprising a processor for processing digital data; a memory device for storing digital data including computer program code, the memory device being in operable communication with the processor; a display device for displaying digital data, the display device being in operable communication with the processor; a user interface adapted for receiving user input data representing user input, the user interface being in operable communication with the processor and wherein, in use, the processor is controlled by the computer program code to display, using the display device, a graphical user interface, wherein the graphical user interface comprises a social node region representing at least one node of a social graph; and an item region representing at least one item; receive, via the user interface, the item relation creation user input data representing an item relation creation user input; and create a relationship between the at least one node and the at least one item in accordance with the user input data.

According to another aspect, there is provided a computing device for relating nodes and items in a social graph, the computing device comprising: a processor for processing digital data; a memory device for storing digital data including computer program code, the memory device being in operable communication with the processor; a display device for displaying digital data, the display device being in operable communication with the processor; a user interface adapted for receiving user input data representing user input, the user interface being in operable communication with the processor and wherein, in use, the processor is controlled by the computer program code to: display, using the display device, a graphical user interface, wherein the graphical user interface comprises: a social node region representing at least one node of a social graph; and an item region representing at least one item; receive, via the user interface, the item relation creation user input data representing an item relation creation user input; and create a relationship between the at least one node and the at least one item in accordance with the item relation creation user input data.

The computing device, by displaying the graphical user interface (as substantially shown in FIGS. 10 to 14 as described in further detail on the detail description) is able to allow users to configure relationships within a social graph between users and items. These items may represent many things, including e-commerce items and the like and, using the graphical user interface, a user is able to configure the relationship between him and herself (i.e. Kyle wants a Toshiba laptop) and a particular item and between the user's social relations and a particular item (i.e. Kyle wants to get perfume for his wife).

The user input data may represent the association of the at least one node with the at least one item. Specifically, the item relation creation user input may comprises a drag and drop gesture having a source coinciding with a display location of the at least one node and a target coinciding substantially with a display location of the at least one item.

Using the graphical user interface, the user is able to drag user node icons representing nodes within a social graph to items so as to create relations between the nodes and the items.

The user input data may represent the association of the at least one item with the at least one node. Specifically, the item relation creation user input comprises a drag and drop gesture having a source coinciding with a display location of the at least one item and a target coinciding substantially with a display location of the at least one node.

Similarly, using a graphical user interface, the user is able to drag items onto nodes so as to similarly create relations between nodes and items.

Preferably, the graphical user Interface further comprises an event region representing at least one event, and wherein, in use, the processor is controlled by the computer program code to receive, via the user interface, event relation creation user input data; and create a relationship between the at least one item and the at least one event.

So too, over and above being able to create relations within a social graph between user nodes and items, can a user, using the graphical user interface, additionally create relationships between items and events. For example, the user may wish to create a relationship between an item associated with him or herself and an event (i.e. Kyle wants a Toshiba laptop for his birthday) or create relationships between items associated with friends and events (i.e. Kyle wants to buy perfume for his wife for their wedding anniversary).

The user input data may represent the association of the at least one item with the at least one event. Specifically, the item relation creation user input may comprise a drag and drop gesture having a source coinciding with a display location of the at least one item and a target coinciding substantially with a display location of the at least one event. Alternatively, the user input data may represent the association of the at least one event with the at least one item. Furthermore, an event may have a ‘host’, where the host is not the creator of the event. For example a user may create an event e.g. a “surprise party” for Kyle, who is the host. Also, an event can be associated with other users who have been ‘invited’ to the event. In particular arrangements, the creator of an event may choose for the event to be private, and may be provided the opportunity to choose who is able to see the event. For instance, so as not to spoil the surprise for Kyle, the user creating the ‘surprise party’ event can choose for the event to be hidden from Kyle, even though Kyle is the host of the party. Of course, each user who is invited to the party will automatically be added to the group of users able to see the event details so they can participate in interactions with the event node, such as for example gift lists for the host, updates as the event approaches etc. In preferred arrangements, the gifts available on the gift register may be sourced from one or more vendors so that the creator or host of the event gift register is not limited solely to the goods which are available from any one vendor alone. In a similar manner, the system may also be utilised by users to create a register associated with each event. For example, the event may be associated with a ‘gift register’ i.e. a list of gifts selected by the creator or host of an event, such as for example for a wedding.

The user input data may represent the association of the at least one node with the at least one item. The item relation creation user input may comprise a drag and drop gesture having a source coinciding with a display location of the at least one node and a target coinciding substantially with a display location of the at least one item.

The user input data may represent the association of the at least one item with the at least one node.

The item relation creation user input may comprise a drag and drop gesture having a source coinciding with a display location of the at least one item and a target coinciding substantially with a display location of the at least one node.

The graphical user interface may further comprise: an event region representing at least one event, and wherein, in use, the processor is controlled by the computer program code to: receive, via the user interface, event relation creation user input data; and create a relationship between the at least one item and the at least one event.

The user input data may represents the association of the at least one item with the at least one event. The item relation creation user input may comprise a drag and drop gesture having a source coinciding with a display location of the at least one item and a target coinciding substantially with a display location of the at least one event.

The user input data may represent the association of the at least one event with the at least one item. The item relation creation user input may comprise a drag and drop gesture having a source coinciding with a display location of the at least one event and a target coinciding substantially with a display location of the at least one item.

Creating the relationship may comprise causing the update of social graph data.

The computing device may further comprise a network interface adapted for sending and receiving data across a data network, the network interface may be in operable communication with the processor and wherein, in use, the processor may be further controlled by the computer program code to: send, via the network interface to a social graph server, social graph update data representing the relationship.

The at least one node may represent a friend node selected in accordance with at least one social relationship within a social graph.

The at least one node may comprise at least two nodes comprising a first node representing a user node within the social graph and the friend node.

The at least one item may be selected in accordance with at least one social relationship within a social graph.

The at least one event may be selected in accordance with at least one social relationship within a social graph.

The user interface may be a touch sensitive user interface. The user interface may be overlaid on the display device.

The social graph may be integrated with one or more social media platforms controlled by a user wherein nodes of the social graph may be derived from the user's social connections within the one or more social media platforms.

One or more nodes of the social graph may comprise media content to provide a rich user experience, wherein the media content may be selected from the group comprising a photographic image, video, audio, or barcode.

A user of the system may be a vendor of good and/or services. The vendor user may be capable of promoting said goods or services via one or more nodes of the social graph.

Specifically, the item relation creation user input may comprises a drag and drop gesture having a source coinciding with a display location of the at least one event and a target coinciding substantially with a display location of the at least one item.

In this manner, the user can simply drag and drop items onto events and events onto items (or, more generally, any node on to any other node) so as to create the relations within the social graph between the particular nodes, i.e. items, events and/or users.

Creating the relationship thereby causes the update of social graph data. Specifically, the computing device may further comprise a network interface adapted for sending and receiving data across a data network, the network interface being in operable communication with the processor and wherein, in use, the processor is further controlled by the computer program code to send, via the network interface to a social graph server, social graph update data representing the relationship.

As such, whereas the computing device may be a client computing device such as a tablet computing device, mobile telecommunication device and the like, upon interacting with the graphical user interface, the computing device is adapted to send social graph update data across a network to a social graph server so as to record the created relationship.

In one embodiment, the at least one node represents a friend node selected in accordance with at least one social relationship within a social graph. Additionally or alternatively the at least one node comprises at least two nodes comprising a first node representing a user node within the social graph and the friend node.

In this manner, within the social node region, there may be displayed a node representing the user him or herself (i.e. Kyle himself) and friends of the user (i.e. Kyle's friends and groups). In this manner, by interacting with the graphical user interface, the user is able to create relations not only in between him or herself and events and items but also between social friends and events and items.

The at least one item may be selected in accordance with at least one social relationship within a social graph.

As such, in this manner, as opposed to be able to simply interact with items created by the user him or herself, the user is able to interact with items created by the user's friends within the system. For example, Kyle is able to see a Toshiba laptop which has been imported into the system by his friend Sarah. As such, Kyle can subsequently create a relationship between himself or others and the Toshiba laptop if he decides to do so.

The at least one event may be selected in accordance with at least one social relationship within a social graph.

Similarly, the graphical user interface is adapted to display events not only relating to the user him or herself (i.e. Kyle's birthday) but also events relating to friends of the user (i.e. Kyle's wife's birthday). In this manner, Kyle may decide to create a relationship between an item and an events relating to another user within the social graph (i.e. his wife).

The user interface may be a touch sensitive user interface and overlaid the display device.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a system on which the various embodiments described herein for relating nodes and items in a social graph may be implemented in accordance with an embodiment of the present invention;

FIG. 2 shows a computing device on which the various embodiments described herein of relating nodes and items in social graph may be implemented in accordance with an embodiment of the present invention;

FIGS. 3A to 3C show exemplary social graph representations showing relationships between nodes, items and events in accordance with an embodiment of the present invention;

FIGS. 4 to 14 show exemplary graphical user interfaces adapted for relating nodes and items in social graph in accordance with embodiments of the present invention;

FIGS. 15A to 15C show object role model depictions of the social graph nodes and relationships for the social interaction systems disclosed herein; and

FIGS. 16A to 16C show detailed object role model depictions of the social graph nodes and relationships for social interaction systems between a user (specifically a User Profile), a Vendor, and Events.

### DESCRIPTION OF EMBODIMENTS

It should be noted in the following description, that like or the same reference numerals in different embodiments denote the same or similar features.

### System 100 of Computing Devices

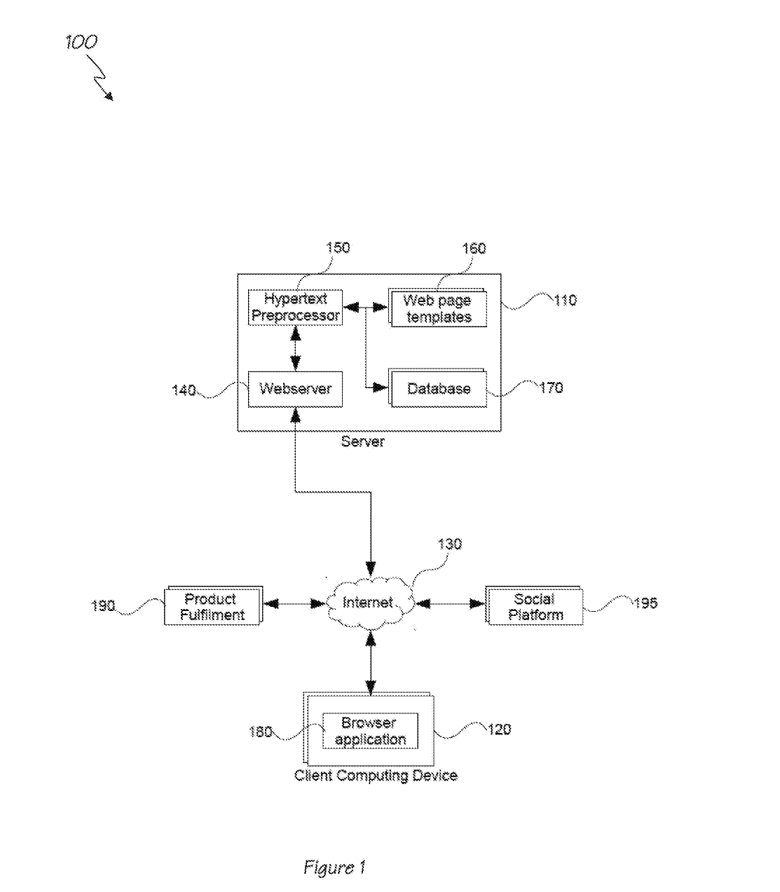

FIG. 1 shows a system 100 of computing devices adapted for relating nodes and items in a social graph.

Specifically, and in other words, and as will be described in further detail below, in embodiments, the system 100 is adapted for facilitating “social shopping” wherein users of social network, using various types of computing devices, can create relationships between themselves and various shopping items (but not necessarily limited to shopping items per se), between their friends and these shopping items and assign shopping items to various occasions. In this manner, the system 100 advantageously facilitates an e-commerce system based on social recommendations, distinguished from both traditional social platforms and e-commerce systems.

The system 100 comprises a server 110. In a preferred embodiment of the functionality described herein is implemented across the system 100 in the form of a web-server architecture wherein the server 110 is adapted for serving web pages to one or more client computing devices 120 over the Internet 130.

As such, in this preferred embodiment, the server 110 is a web server having a web server application 140 for receiving requests, such as Hypertext Transfer Protocol (HTTP) and File Transfer Protocol (FTP) requests, and serving hypertext web pages or files in response. The web server application 140 may be, for example the Apache™ or the Microsoft™ IIS HTTP server.

The server 110 is also provided with a hypertext preprocessor 150 for processing one or more web page templates 160 and data from one or more databases 170 to generate hypertext web pages. The hypertext preprocessor may, for example, be the PHP: Hypertext Preprocessor (PHP) or Microsoft ASP™ hypertext preprocessor. The web server 110 is also provided with web page templates 160, such as one or more PHP or ASP files.

Upon receiving a request from the web server application 140, the hypertext preprocessor 150 is operable to retrieve a web page template, from the web page templates 160, execute any dynamic content therein, including updating or loading information from the one or more databases 170, to compose a hypertext web page. The composed hypertext web page may comprise client side code, such as Javascript, for Document Object Model (DOM) manipulating, asynchronous HTTP requests and the like.

Furthermore, the system 100 comprises a plurality of client computing devices 120. The client computing devices 120, as will be described in further detail below, may be different types of computing devices depending on the application. Generally, the client computing devices 120 are utilised by the users of the social platform in capturing item data representing one or more items, creating relations between the items, themselves and their friends, and assigning the items to one or more events or occasions. In this manner, the client computing devices 120 may take the form of traditional desktop computing devices, or mobile computing devices, such as mobile smart phones, tablet computing devices and the like.

In one embodiment, the client computing devices 120 are provided with a browser application 180, such as the Mozilla Firefox™ or Microsoft Internet Explorer™ browser applications. The browser application 180 requests hypertext web pages from the web server 110 and renders the hypertext web pages on a display device 1020. Specifically, the browser application 180 may be adapted to render the various exemplary graphical user interfaces described below. In alternative embodiments, the client computing devices 120 may be provided with application software so as to render the various exemplary graphical user interfaces in other manners.

Furthermore, the system 100 is adapted for communication with one or more social platform servers 195. As will become apparent from the description below, the users of the system 100 are adapted to utilise their existing social networks when creating relationships with items, events and the like. For example, users of the system 100 may configure their client computing device 120 to authenticate with the Facebook™ social platform server 195 for example so as to have access to their friends when creating relationships between themselves, their friends and items.

It should be noted that in other embodiments, the system 100 need not necessarily interface with third-party social platform service 195. Rather, the server 110 may be adapted to implement the social graph itself. For example, during configuration, the server 110 may be configured with one or more e-mail addresses, or even import e-mail addresses from an e-mail platform, such as the Gmail™ platform to serve as the basis for the social graph.

In further embodiments, the server 110 may be adapted to update the social graph data of the third-party social platform service 195 in accordance with the user interactions with the server 110. Such updates may comprise status updates, wall feed updates, friend requests and the like.

In a further embodiment, the system 100 is adapted for interaction with a product fulfillment server 190 for the purposes of ordering products. For example, having created a link between a person and an item, the person may then utilise the system 100 for the purposes of ordering the item.

It should be noted that the architecture provided in FIG. 1 is exemplary only and that the various technical actors may be modified within the purposive scope of the embodiments described herein. For example, and as alluded to above, all of the functionality of the product fulfillment, social platform and creating relationships between nodes of social graph and items may be performed by a single server 110, as opposed to the three discrete server instances provided in FIG. 1.

### Computing Device

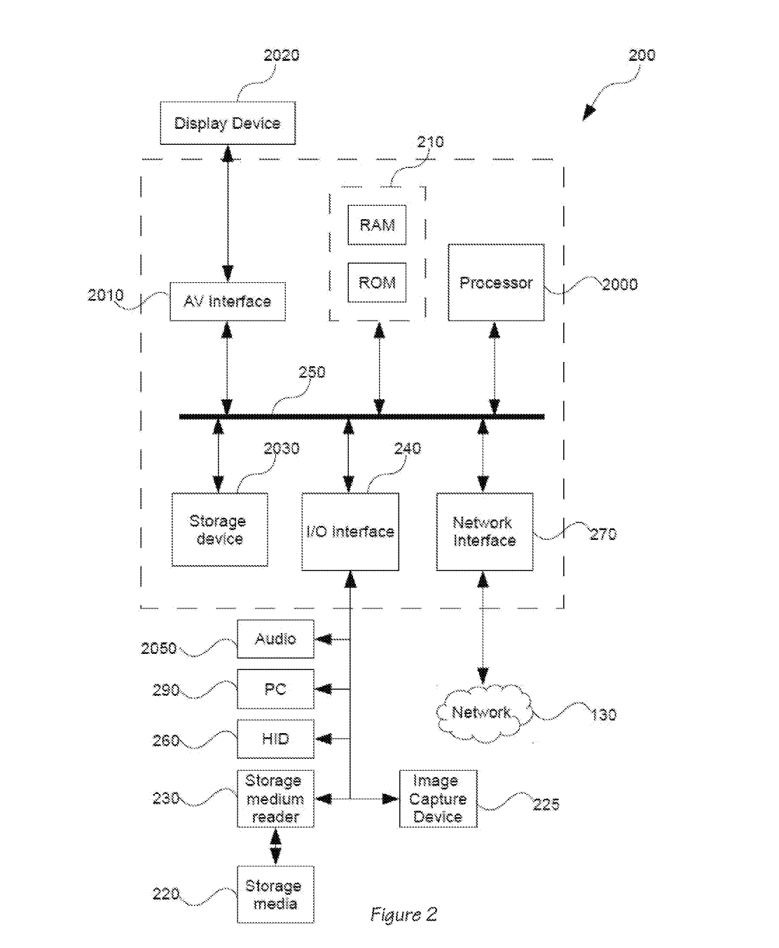

FIG. 2 shows a computing device 200. The computing device 200 may take on the differing computing embodiments as given in FIG. 1. Specifically, the computing device 200 may take the form of a server 110, client computing device 120, product fulfillment server 190, social platform server 195 and the like.

In this manner, the computing device may comprise differing technical integers, depending on the application. For example, where the computing device 200 takes the form of the client computing device 120, the computing device 200 may comprise the display device 2020, image capture device 225 and the like which would otherwise not be required should the computing device 200 take the form of the server 110, for example.

As such, the technical integers of the computing device 200 as shown in FIG. 2 are exemplary only and variations, adaptations and the like may be made thereto within the purposive scope of the embodiments described herein and having regard for the particular application of the computing device 200.

In particular the steps of the method for creating relationships between nodes of the social graph and items, as described in further detail below, may be implemented as computer program code instructions executable by the computing device 200. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 200 comprises semiconductor memory 210 comprising volatile memory such as random access memory (RAM) or read only memory (ROM). The memory 200 may comprise either RAM or ROM or a combination of RAM and ROM.

The device 200 comprises a computer program code storage medium reader 230 for reading the computer program code instructions from computer program code storage media 220. The storage media 220 may be optical media such as CD-ROM disks, magnetic media such as floppy disks and tape cassettes or flash media such as USB memory sticks.

The device further comprises I/O interface 240 for communicating with one or more peripheral devices. The I/O interface 240 may offer both serial and parallel interface connectivity. For example, the I/O interface 240 may comprise a Small Computer System Interface (SCSI), Universal Serial Bus (USB) or similar I/O interface for interfacing with the storage medium reader 230. The I/O interface 240 may also communicate with one or more human input devices (HID) 260 such as keyboards, pointing devices, joysticks and the like.

The I/O interface 240 may also comprise a computer to computer interface, such as a Recommended Standard 232 (RS-232) interface, for interfacing the device 200 with one or more personal computer (PC) devices 290. The I/O interface 240 may also comprise an audio interface for communicate audio signals to one or more audio devices 2050, such as a speaker or a buzzer.

The I/O interface 240 may further comprise an image interface for receiving image or video data from an image capture device 225. Such is especially advantageous in the embodiments described below where the computing device 200 takes the form of a mobile computing device and wherein the user of the mobile computing device is able to create digital items within the system 100 by taking photographs of the real-world items using the camera of the mobile computing device.

The device 200 also comprises a network interface 270 for communicating with one or more computer networks 280. The network 280 may be a wired network, such as a wired Ethernet™ network or a wireless network, such as a Bluetooth™ network or IEEE 802.11 network. The network 280 may be a local area network (LAN), such as a home or office computer network, or a wide area network (WAN), such as the Internet or private WAN.

The device 200 comprises an arithmetic logic unit or processor 2000 for performing the computer program code instructions. The processor 2000 may be a reduced instruction set computer (RISC) or complex instruction set computer (CISC) processor or the like. The device 200 further comprises a storage device 2030, such as a magnetic disk hard drive or a solid state disk drive.

Computer program code instructions may be loaded into the storage device 2030 from the storage media 220 using the storage medium reader 230 or from the network 280 using network interface 270. During the bootstrap phase, an operating system and one or more software applications are loaded from the storage device 2030 into the memory 210. During the fetch-decode-execute cycle, the processor 2000 fetches computer program code instructions from memory 210, decodes the instructions into machine code, executes the instructions and stores one or more intermediate results in memory 200.

In this manner, the instructions stored in the memory 210, when retrieved and executed by the processor 2000, may configure the computing device 200 as a special-purpose machine that may perform the functions described herein.

The device 200 also comprises a video interface 2010 for conveying video signals to a display device 2020, such as a liquid crystal display (LCD), cathode-ray tube (CRT) or similar display device.

The device 200 also comprises a communication bus subsystem 250 for interconnecting the various devices described above. The bus subsystem 250 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Social Graph 300

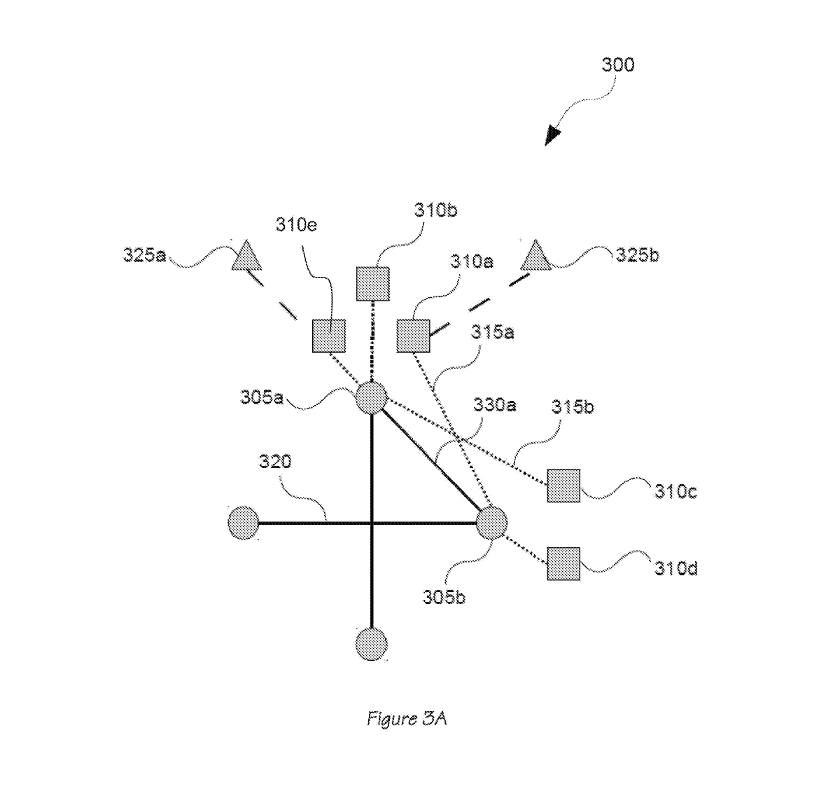

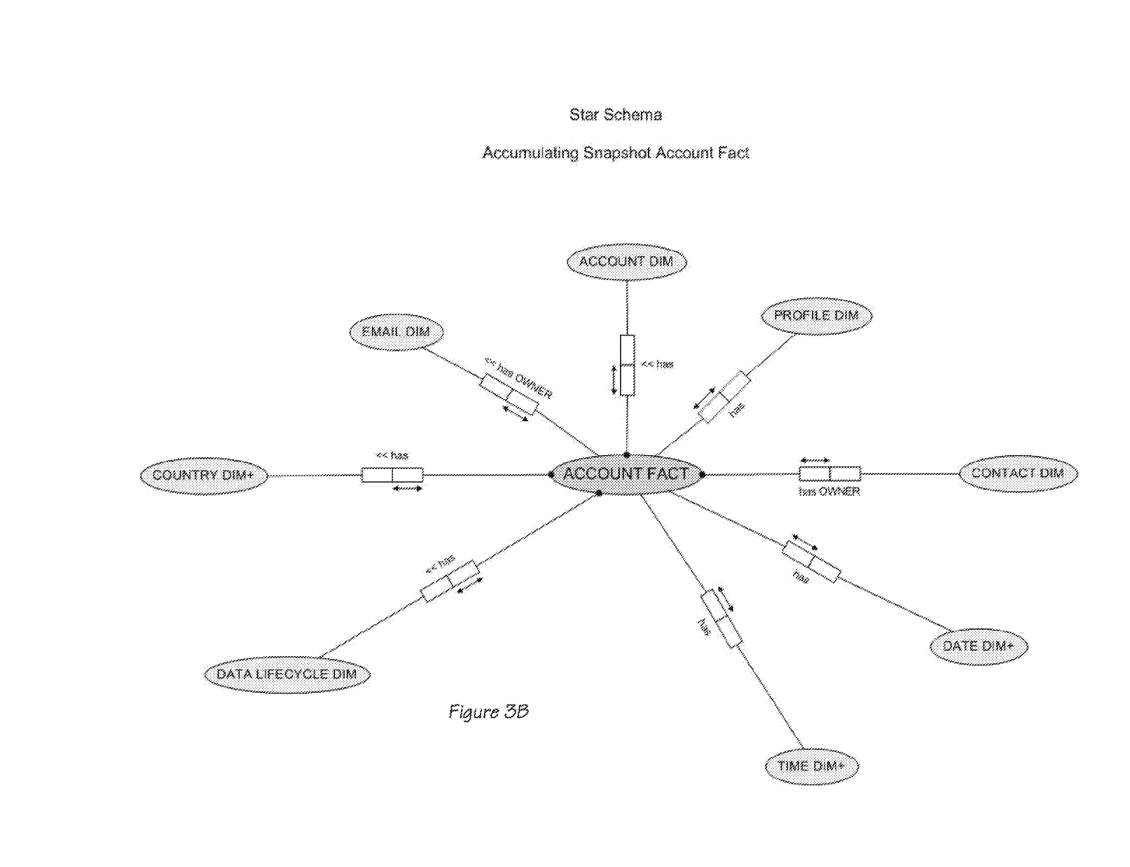

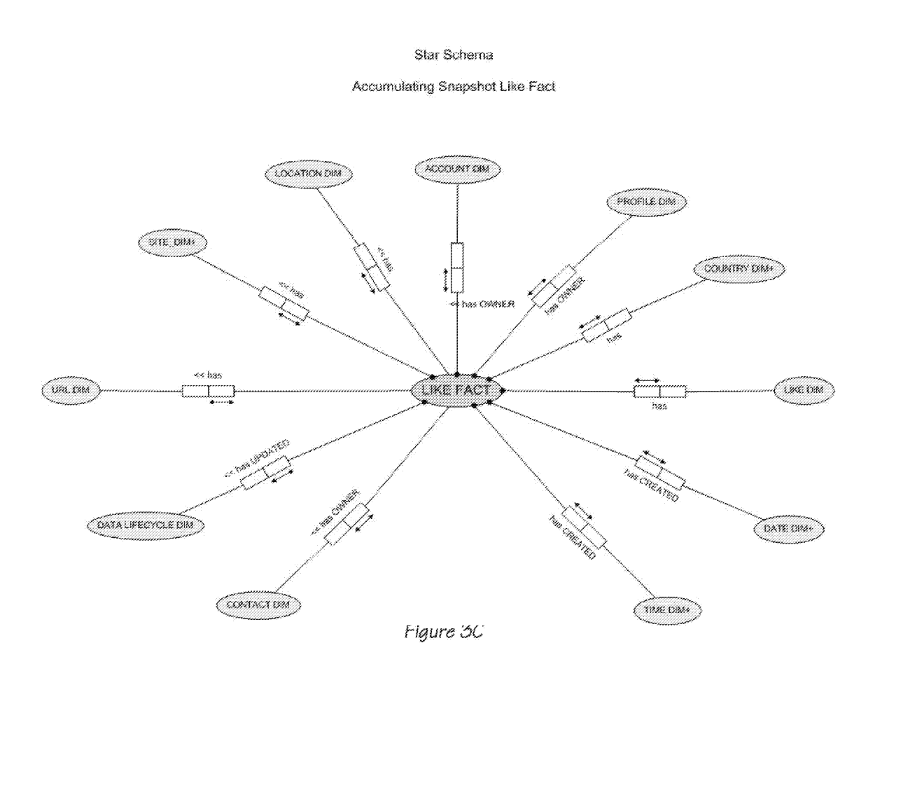

As seen in FIG. 3A there is an exemplary social graph 300 showing the relationships between nodes 305, items 310 and events 325.

Should be noted that the term “nodes” as used herein may represent any node of the social graph but generally represents a person. In this manner, the nodes of the social graph 300 represent people and the relationships between these people. However, it should be noted that the nodes need not necessarily be limited to representing people and may represent other objects also such as groups of people, entities, organizations, websites and the like.

In the exemplary social graph 300, the social graph 300 comprises four people nodes 305. The relationships between the people nodes is represented by the node relationships 320 represented in solid lines. As is apparent, in the social graph 300 by node relationship 330a, person 305a is related to person 305b, that is, they are “friends”.

Now, the embodiments described herein are distinguished at least on account of the social graph 300 be able to represent relations between people nodes 305 and items 310.

In the preferred embodiments described herein, especially where the system 100 is adapted for use in social shopping, the items 310 represents things for purchase, such as cameras, perfume, books and the like. In this manner, and as will be described in further detail below, users of the system 100 may create relationships between themselves or other related/associated users and items so as to represent that they like these items so as to, in other words, create a “wish list” for these items. Specifically, the links between the people nodes 305 and the items 310 represented by the item links 315 shown in dotted lines.

As is apparent, user 305a has created a relationship with items 310b, 310c, and 310e.

However, and as will be described in further detail below, the users of the system 100 may create links between items and other people nodes of the social graph 300. As is apparent also, the social graph 300 comprises an item link 315a between user 305b and item 310a.

Yet further, the embodiments described herein are yet further distinguished from existing arrangements at least by being able to further create relations between items 310 and events 325. Events may represent any future event which may be a once off event such as a christening, recurring event such as a birthday or wedding anniversary and the like. In this manner, users of the system 100 over and above being able to create relations between people and items of the social graph 300 and are able to further assign the items to particular events 325 so as to, for example, be able to purchase items for a particular event.

### Creating Relationships Between Nodes of the Social Graph and Items

Now, in the description below, there will now be described exemplary user interactions with the system 100 in creating relationships between nodes of the social graph 300 and items 310.

It should be noted that these user interactions are exemplary only and no technical limitations should necessarily be imputed to the embodiments described herein accordingly.

Addition of an Item from the Browser Application 180

The initial user interactions relates to the addition of items to the system 100 for storage within the database 170.

As such, the first use interaction relates to the addition of an item from the browser application 180 executed by the client computing device 120.

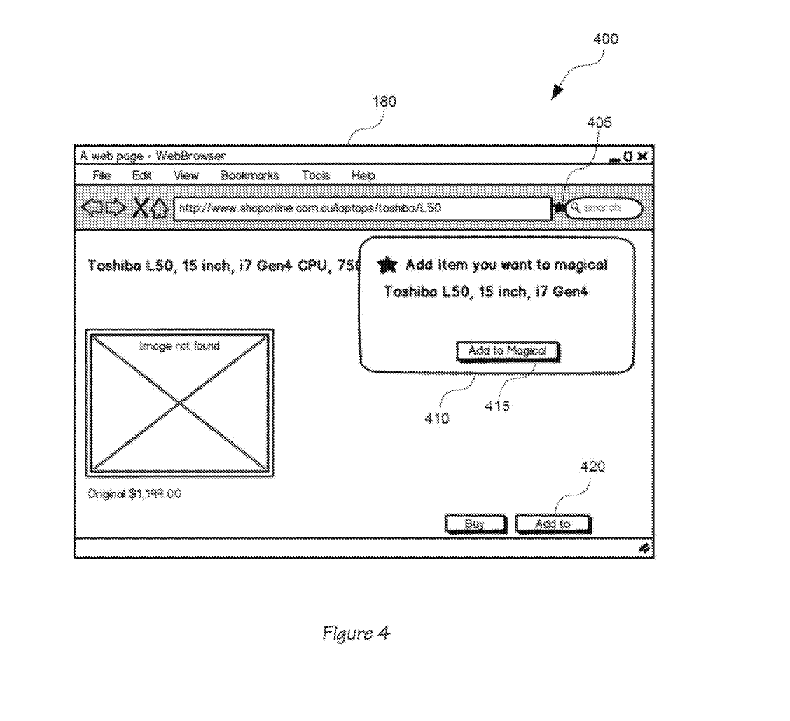

Specifically, referring to FIG. 4, there is shown an exemplary graphical user interface 400 showing the browser application 180 configurable for allowing the user to add an item to the database 170.

Specifically, as is apparent, the user is currently browsed to a URL relating to a Toshiba laptop. Now, should the user be interested in the laptop, or know a friend who would be interested in a laptop, the user may utilise the browser add-on or extension to add the item to the database 170 using add button 405.

In this manner, the user may have previously installed the add-on or extension 405 specifically relating to the browser application 180 so as to display the add button 405 in the browser bar.

Activating the add button 405 executes a program code portion (e.g. a JavaScript script or program) that creates a pop-up window 410 comprising further information relating to the item and the further button 415 confirming the user's addition of the item to the system 100.

It should be noted that the system is represented in the drawings is referred to as “Magical”—the trademark for the system 100.

The add-on or extension may retrieve certain details relating to the item for display within the pop-up 410. Specifically, the add-on or extension may be configured for parsing the HTML such as in looking for H1 HTML tags or the like for the purposes of identifying the name of the item.

In other embodiments, the HTML of the page relating to laptop may comprise other meta data more readily accessible by the add-on or extension in retrieving the relevant information.

Now, upon activation of the add button 415, the add-on or extension sends, via the Internet 130, to the server 110 the item data relating to the Toshiba laptop. As will be described in further detail below, upon subsequent authentication with a server 110 the user is able to view a list of recently added items for review prior to association with their profile.

It should be noted that the association of the item with a particular node of the social graph or event need not necessarily occur at this stage. Rather, such association may be made during the above list review process.

It should be noted that in the exemplary embodiment, there is shown only the capturing of the title of the item. However, in other preferred embodiment, the add-on or extension is adapted to capture other information also, such as a representative image of the item, the recommended retail price of the item, the URL of the item and the like.

It should be noted that in other embodiments, as opposed to the functionality of the add-on or extension be accessible within the browser bar of the browser application 180, in one embodiment, the add-on or extension is adapted to identify e-commerce pages and the like and manipulate the Document Object Model (DOM) as discussed above to create an “Add-To” button 420 as an alternative to utilising the add button 405.

For example, the add-on or extension may inspect each webpage looking for submit elements and the like comprising the value “Buy” or variations thereof so as to be able to insert the child input button 420 element.

The Addition of an Item from a Mobile Computing Device

Now, as opposed to the user utilising a browser add-on or extension to add an item to the database 170, in other embodiments, the system 100 may be adapted to capture items in other manners, including real-world items.

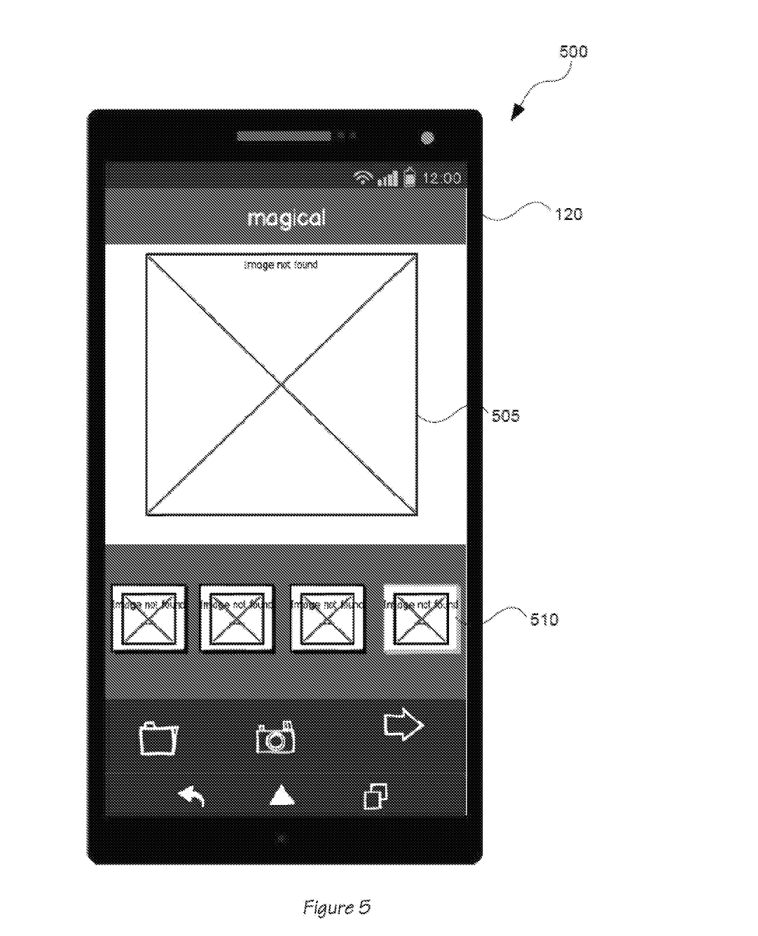

As such, referring to the exemplary graphical user interface 500 as given in FIG. 5, there is shown an example where the client computing device 120 takes the form of a mobile communication device such as a smartphone or the like.

In this manner, as opposed to be limited to capturing information from web pages relating to items, the user, using the smart phone, may create items in the database 170 representing real-world items.

For example, when shoe shopping, upon finding a particularly nice pair of shoes, the user, using the camera of the smart phone, may capture an image of the pair of the nice shoes for uploading to the server 110.

Specifically, referring to the exemplary graphical user interface 500, there is shown the interface 500 comprising an image capture portion 505 allowing the user to frame and capture the image of the item. Furthermore, the interface 500 may comprise previously captured images 510 selectable by the user for uploading to the server 110.

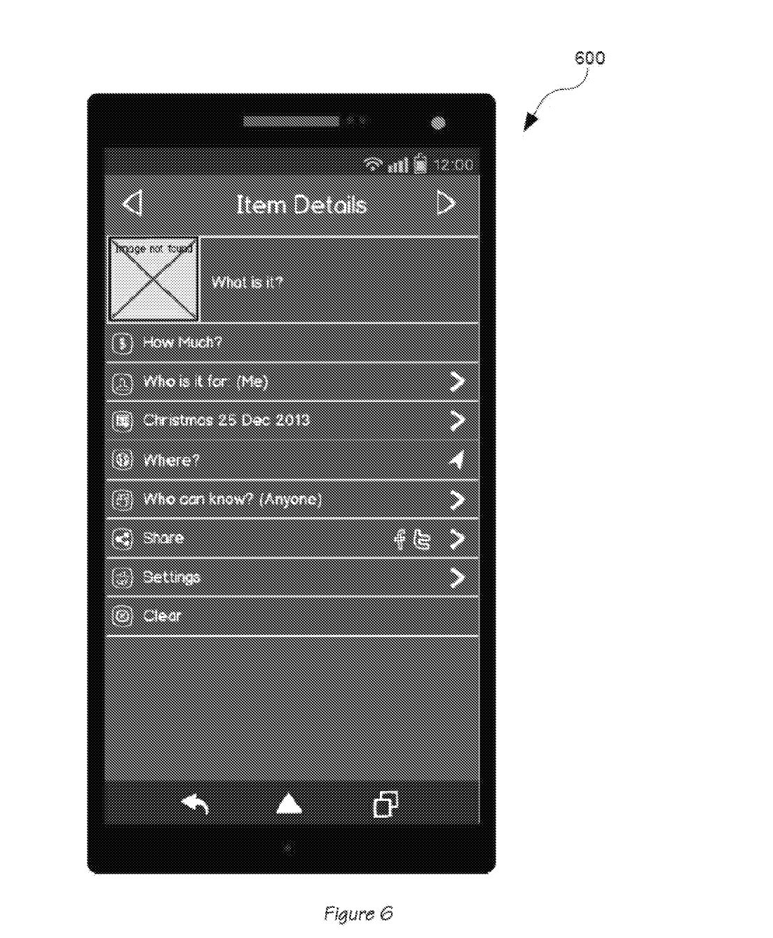

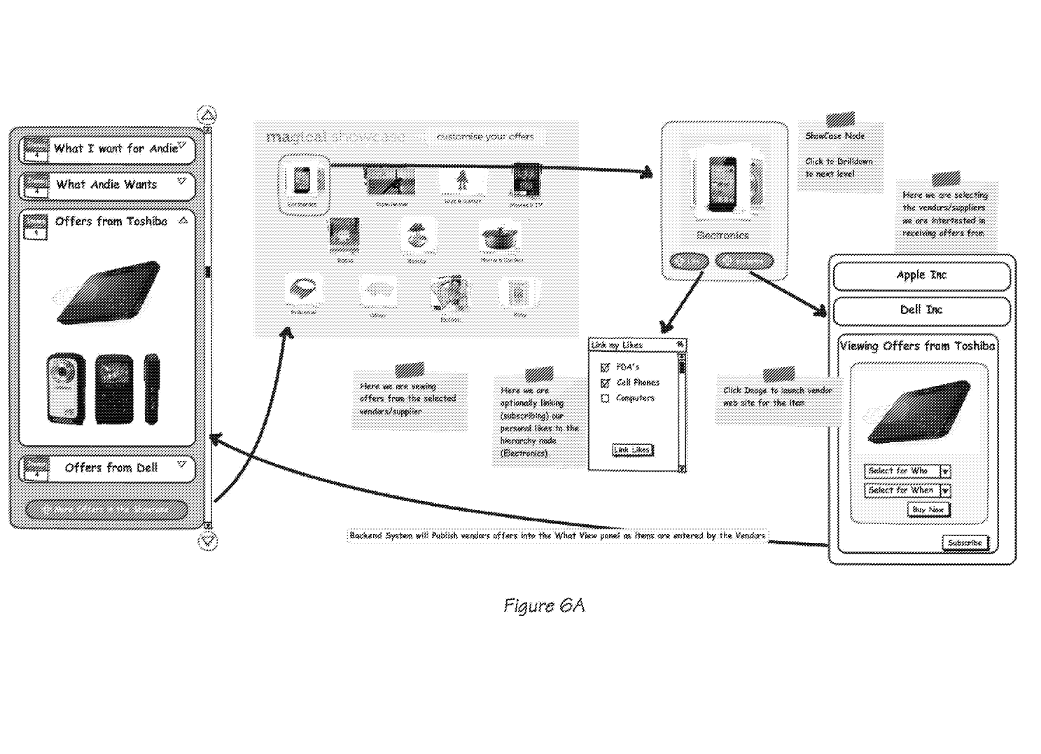

Furthermore, having captured an image, or having selected an image for upload to the server 110, the mobile communication device may display the exemplary graphical user interface 600 as substantially shown in FIG. 6 allowing the user to further configure the item.

Specifically, the user may enter the name of the item and the price of the item. Furthermore, the user may further input information to create relationships between the items and themselves and friends, and relationships between the items and events. These relationships will be described in further detail below.

Now, as opposed to the user utilising the above-disclosed means for associating items with user social graph 300, the system 100 may be adapted to serve items directly from vendors to the users. In order for each user to interact with the vendor system, each user of the social graph 300 has a unique user “Account”. Within each user account a user may have multiple “Profiles” wherein each profile is synonymous with a type of social media broadcaster, for example, Facebook™, LinkedIn™, Twitter™, Instagram™, MySpace™ and the like.

Further, within each profile, each user has one or more “Friends” and the user is provided with the ability to group subsets of their friends together for example, work friends, family, and the like.

As discussed above each profile is able to be associated with one or more “Events”, for example, birthdays, BBQs, weddings, anniversaries etc. wherein events may be “Recurring Events”, e.g. birthday's or anniversaries. The system 100 may also interact closely with the user's social media accounts e.g. Facebook, and may be selectively adapted to synchronise the user's friends and/or events from the social media account. The system may also be adapted to distinguish between events organised by the user against those organised by their friends. Similarly to existing social media platforms, the system 100 may provide ability for users to “Like” a node of the social graph 300 e.g. a friend or event, and the user is automatically subscribed to be alerted to changes or updates to the ‘Liked’ node entity. In particular arrangements, each like may also comprise media content such as a photographic image, video, audio, or barcode to provide a rich user experience. The media content may be organised into “Albums” which may be associated with a particular Profile within a user Account. In further arrangements of the system, additional hierarchical “Like” levels are also envisaged, for example, in relation to events linked to a specific profile or an event linked to a specific friend. Additionally, each entity (e.g. Profile, Event, Album, etc.) within each user node may have a unique security level configurable by the user. For example, a user may wish to restrict attendance at a particular event to only their friends within a particular profile, for example, a Christmas lunch Event may be restricted to family members only. Accordingly, the user's friends outside the family profile would not have access to the Christmas lunch Event.

In the broader landscape of the system a user may “Like” a vendor or one or more specific products from a particular vendor. Accordingly the system 100 integrates an interaction class of a VendorLike so that users may choose to subscribe to updates, product availability or product discounts or events associated with the vendor. The vendor node is adapted to provide a virtual store available to users of system 100, wherein products offered for sale by each vendor or are made available to users to browse and obtain product information specific to each product, and in accordance with the procedures described above, may associate a vendor's particular product with a node of the social graph 300.

In further arrangements, a user may subscribe to a specific topic/subject area, market segment or class of products, for example, computer hardware, or women's shoes. In this way the user is not limited to receiving updates from a single vendor alone, but instead will receive updates from a variety of vendors, each of which offer products or services within the particular topic area selected by the user.

Facilitated by the system 100, vendors may offer VendorEvents such as a product sale event whereby the VendorEvent may be promoted to particular users of system 100 via one or more nodes of the social graph 300, particularly to users who have indicated a preference for products offered for sale by the vendor offering the VendorEvent or users who have indicated a preference for information pertaining to a particular class of products, e.g. electronics, fashion etc. similar to those product classes being offered for sale by the vendor in the VendorEvent. In particular arrangements, the system 100 may offer a “Showcase” such as is shown in FIG. 6A, which is made available to the users of system 100 via the graphical user interface 600 of the user's mobile communication device as described herein. The Showcase may be tailored particular the vendor to create a vendor specific Showcase or alternatively may be tailored to a profile associated with a specific user for example where the user has indicated a preference electronic items as potential products for association with members of the user's profile, for example, a Showcase may be specifically tailored to a user's unique interests via a personalised configuration based on the user's indicated preferences and subscriptions/likes recorded within system 100. In particular arrangements the items made available on a particular Showcase may comprise goods or services from merely a single vendor, or alternatively may comprise goods available from many vendors.

In particular arrangements the Vendor users of the system comprising social graph 300 may be able to promote their goods and/or services or Vendor Events to users of the system via one or more nodes of the social graph through integration with an existing sales platform, for example, the International TV Shopping System (ITVSS).

### Importing Items

There will now be described the exemplary user interaction wherein, having captured the relevant item data either using the browser application 180 extension or mobile communication device, the user imports the items captured items.

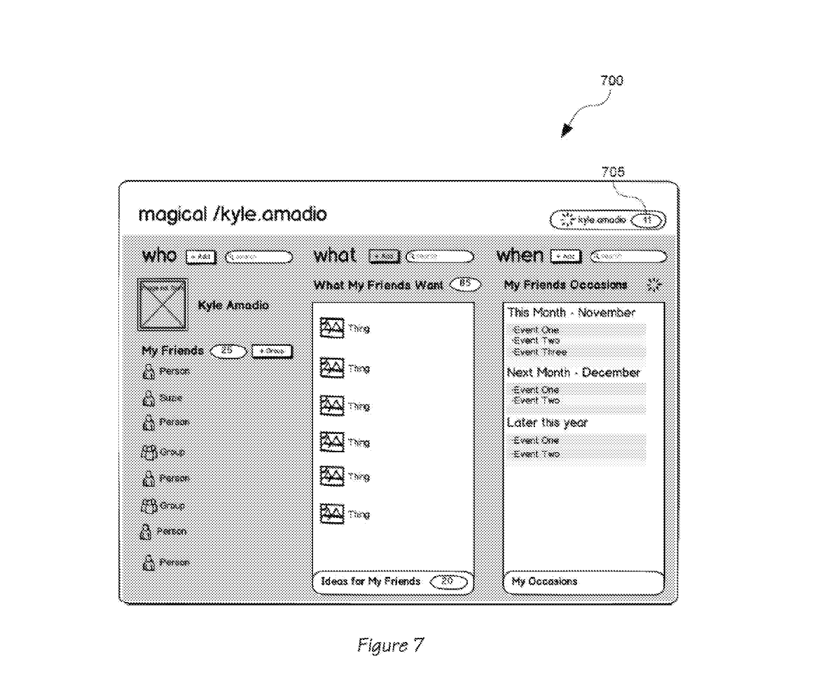

Specifically, referring to the exemplary graphical user interface 700 as substantially given in FIG. 7, there is shown an example interface displaying a number of notifications 705 detailing the number of uploaded items for review by the user. The remainder of the graphical user interface 700 will be described in further detail below.

As such, in order to import these items, the user clicks on the number of notifications 705.

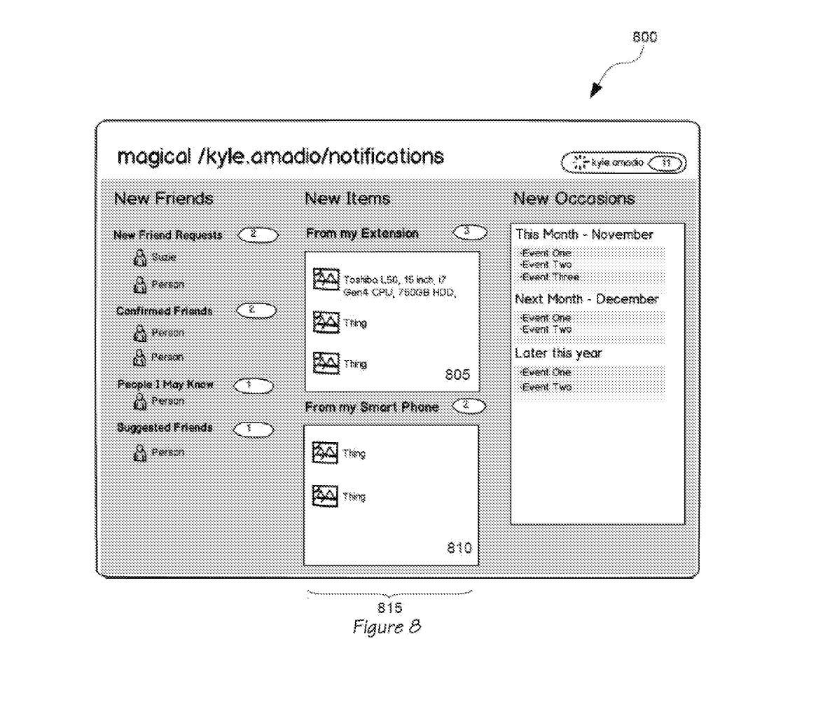

As such, the client computing device 120 is adapted to display the exemplary graphical user interface 800 as substantially shown in FIG. 8.

As is apparent from the interface 800, the interface 800 comprises a new items region 815 displaying the new items which have been uploaded by the user but are awaiting review. As is also apparent, the new items region 815 comprises a first region 805 relating to items uploaded from the user's browser extension and a second region 810 listing the new items uploaded to the server 110 using the user's smart phone client computing device 120.

Now, for each item listed in the new items region 815, the user will select each item in order to configure and import the item.

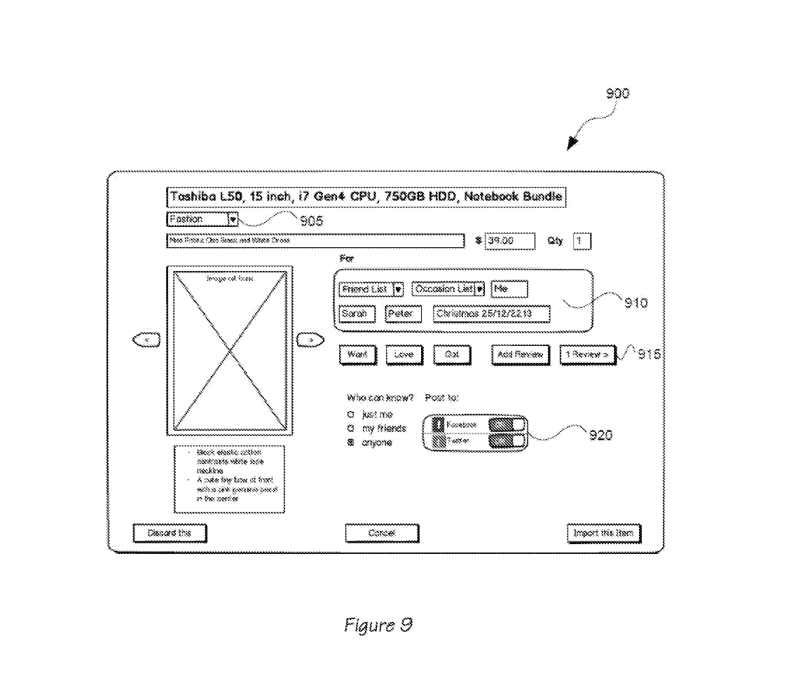

For example, having selected the first uploaded item relating to the Toshiba laptop, the user would be presented by the client computing device 120 the exemplary graphical user interface 900 substantially given in FIG. 9.

As is apparent, the graphical user interface 900 comprises the various information relating to the Toshiba laptop including the title and features, images and other descriptive meta-data. Using the interface 900, the user can categorise the item into one or more item categories using category selector 905.

Furthermore, using the interface 900, the user can optionally create relationships between the item and people from the user social network including themselves and also create relationships between the item and occasions.

For example, in the relationship in input panel 910, the user may specify which person or people for whom the laptop is for. For example, the user has indicated that the laptop is for Sarah and/or Peter. Furthermore, the user has specified the occasion as Christmas in the year 2213. In other words, the user is indicating that the user would like to obtain the Toshiba laptop for Sarah and/or Peter for Christmas.

As is apparent, the interface 900 further allows for the configuration of the privacy settings using privacy panel 920. For example, using the privacy panel 920 the user may wish to keep the item private using the “just me” radio button. Alternatively, the user may wish to publicize the item to anyone of their friends using the “my friend” radio button or alternatively to make an entirely public using the “anyone” radio button. For example, if the person is simply creating a shopping list for Christmas, the user would generally keep a shopping list private. Alternatively, if the person was gathering a group present for example, the person may wish to publicize the item to their friends such that their friends could also be involved in the procurement of the item for the person.

It should be noted that when creating the relationship between the item and social graph nodes, the user can create a relationship between the item and themselves so as to represent that he or she wishes to have the item for him or herself. Alternatively, the user can create a relationship between the item and other people represented by other notes of the social graph 300 representing that the user wishes to obtain or refer the item to other users.

Referring again to the exemplary graphical user interface 300 as substantially given in FIG. 3A, there is shown the relationship between a person 305a and item 310b representing that person 305a wishes to have or otherwise associate with the item 310b.

Furthermore, there is shown a relationship between person 305b and item 310a representing that person 305a has created item 310a but associated the item 310a with another person 305b. In other words, the user 305a wishes the other person 305b to have, or to be otherwise associated with the item 310a created by the person 305a.

Furthermore, over and above creating relationships between person 305 and items 310, the system 100 allows for the further creation of relationships between items and events.

For example, using the above example, the user wishes to create a relationship between the Toshiba laptop and Peter. As such, referring to the social graph 300, there is shown the user 305a having created the Toshiba laptop item 310a, having associated the Toshiba laptop item 310a with Peter person 305b using item link 315a and having created a relationship between the Toshiba laptop item 310a and the Christmas event 325b.

Finally, using interface 900, the user may elect to discard the uploaded item, cancel the importation process, or import the item.

### Create an Item Relationship

Now, having described the item creation and importation process above, there will now be described exemplary interactions wherein users can create relationships between items, social relations and events.

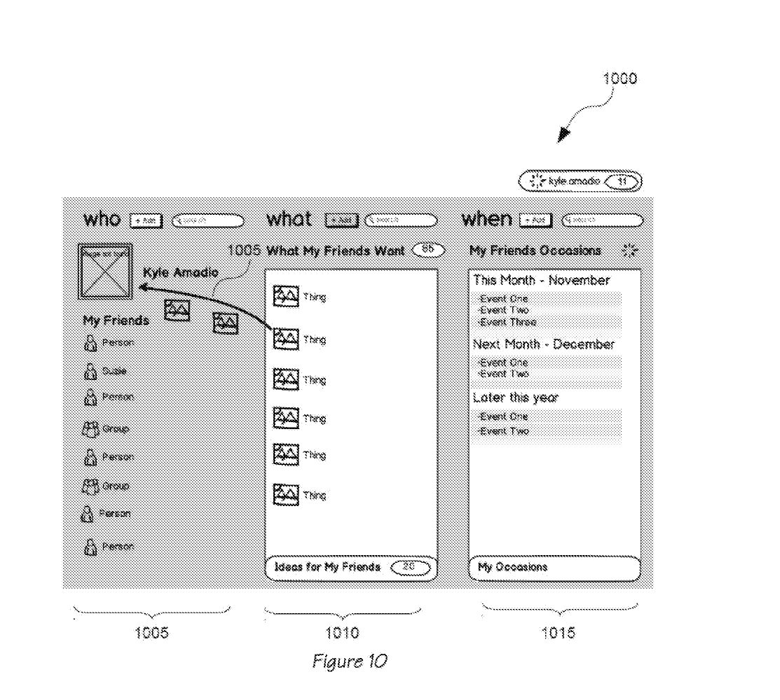

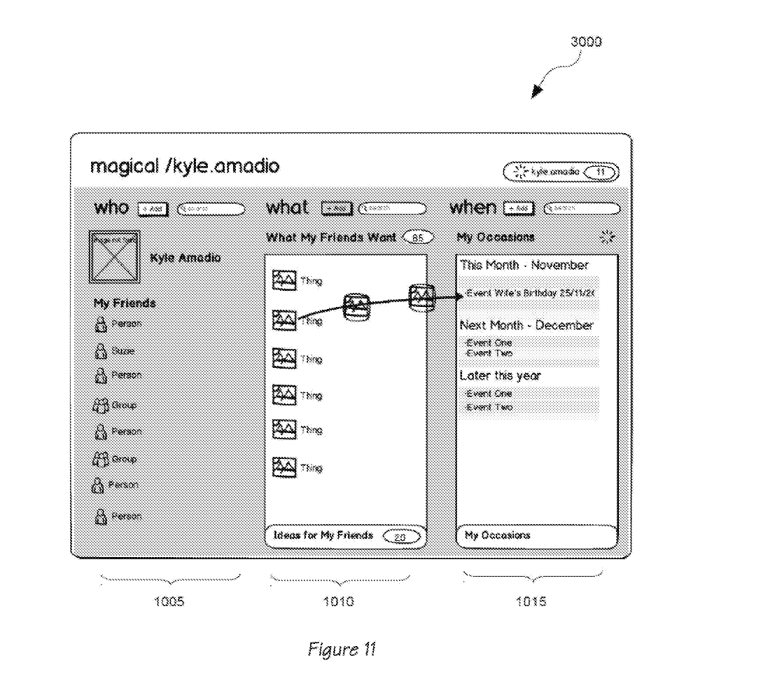

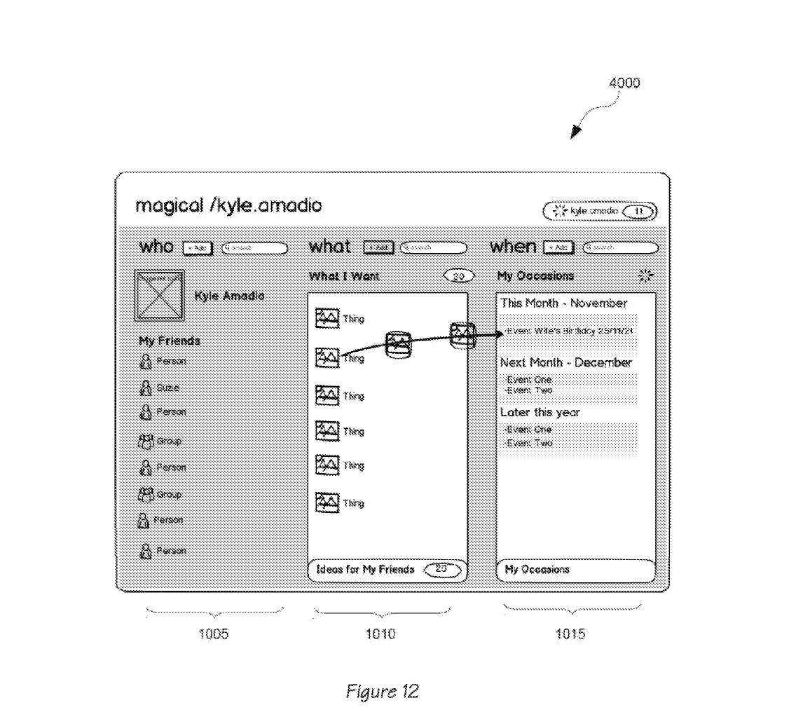

As such, reference is made to FIG. 10, where there is shown an exemplary graphical user interface 1000 representing social users, items and events, and the relations between the three.

Specifically, the interface 1000 comprises a social node region 1005 representing at least one node on the social graph 300. As is apparent, the at least one node on the social graph 300 may represent individual persons, groups and the like. Furthermore, the interface 1000 comprises an item region represented at least one item. Such items may, for example, represent the above exemplary Toshiba laptop imported in the manner described above.

Finally, the interface 1000 comprises an event region 1015 represented at least one event.

Now, there will be described an interaction wherein a user is able to create a relationship between their social profile (i.e. they are a node on the social graph 300) and an item created by a social relation.

Specifically, the item region 1010 is headed by the heading “what my friends want”. In order to present the various items within the item region 1010, the server 110 would traverse all of the social relations of the user and compile a list of all of the items related to those social relations of the user.

For example, and making reference to the exemplary social graph 300 provided in FIG. 3A, for user 305a, the server 110 would, using social relation 330a identify node 305b as being a social relation of user 305a and subsequently identify that item 310d is associated with the social relations 305b. As such, item 310d would be used to populate the item region 1010.

For example, Kyle's friends may wish for various things which Kyle may browse at his leisure. However, Kyle notices that the second item in the item region 1010, being the Toshiba laptop, is something that Kyle was also interested in and wants to have for himself, especially because his birthday is next month. In this manner, Kyle simply, using drag-and-drop gesture, drags the Toshiba laptop item from the item region 110 and drops the item icon over has social profile icon. In this manner, the server 110 knows that Kyle wishes to create a relationship between his social profile (node of the social graph 300) and the Toshiba laptop. In this manner, the server 110 creates an item relationship linking Kyle's social node within the social graph 300 to the Toshiba laptop item.

### Creating an Event Relationship

Referring now to FIG. 11, there is shown an exemplary graphical user interface 300 showing an exemplary interaction wherein the user may use the interface 3000 to create a relationship between items and events.

In a similar manner as described above wherein a server 110 is adapted to traverse the users social graph 300 ascertain those items related to social relations of the user, so to is the server 110 adapted to traverse the user social graph 300 so as to ascertain events relevant to those social relations of the user.

For example, the server 110 traverses Kyle's social graph 300 and ascertains that Kyle's wife is related to Kyle and the social graph 300. Then, the server 110 ascertains that Kyle's wife's birthday is on 21 November and as such, populates the event region with the event. In this manner, the pertinent events relating to Kyle's social relations can be shown in the item region 1015.

For example, should Kyle's wife have previously indicated that she likes a particular type of perfume (i.e., the particular type of perfume would appear as an item within the item region 1010. Now, Kyle, upon inspecting the perfume within the item region may decide that Kyle would like to buy the perfume for his wife for her birthday.

As such, Kyle, using a drag and drop gesture, drags the perfume item from the item region 1010 and a drops the perfume item on top of his wife's birthday event within the event region 1015.

In response, the server 110 creates an event relation between the perfume item and Kyle's wife's birthday event.

It should be noted that the creation of the relationships between the items in the events need not necessarily utilise items associated with social relations of the user. Specifically, exemplary interface 3000 showed the user creating an event relation with an item related to a social relation within the social graph 300.

Similarly, the server 110 is also adapted to create event relations with items related to the user him or herself. Specifically, referring to the exemplary graphical user interface 4000 substantially given in FIG. 4, there is shown the item region 1010 showing those items associated with Kyle's social profile social node. In other words, these are items that have been related to Kyle's social node; that is that Kyle wants these items. As is apparent, above the item region 1010 there is represented “what I want” as opposed to “what my friends want” as given in interface 3000.

Now, using the interface 4000, Kyle is able to similarly create relations between those items that Kyle wants and the events using a similar drag-and-drop gesture as described above. It should be noted that the target events may similarly comprise events associated with Kyle (i.e. Kyle's birthday etc.) or events associated with social relations of Kyle in accordance with the social graph 300. In this manner, if Kyle wants the Toshiba laptop, using the interface 4000, Kyle can represents that Kyle wishes for the Toshiba laptop for his birthday. Alternatively, Kyle can represent that Kyle wishes to purchase or recommend for the Toshiba laptop for a friend's birthday.

Creating Item Relations with Social Relations

Now, above there was described the creation of item relations between items and the user, and the creation of event relations between these items and various events. Now, with reference to the exemplary graphical user interface 5000 substantially given in FIG. 13, there will be shown the exemplary interaction wherein relations are created between items and social relations (friends).

Specifically, referring to the interface 500, the social node region 1005, over and above showing the user profile (i.e. Kyle), is adapted to also display those social relations (friends) of the user as determined by the server 110 from social graph 300. As is apparent, Kyle is at least friends with Susie, as determined by the server 110 from social graph 300.

Now, using the interface 5000, Kyle is able to create associations between items and other users of the social graph 300. Specifically, upon reviewing the items within the item region 1010, Kyle may spot a particular kind of perfume and, knowing that Susie loves perfume, using a drag-and-drop gesture, associates the perfume with Susie. In doing so, the server 110 creates a relationship between the perfume item and Susie. Additionally, Kyle can determine whether Suzie or others can know about the relationship thus created.

It should be noted that in various embodiments, the server 110 may be configured to characterise the type of item relation created between the item and Susie by Kyle. In one manner, the item is a standard item relation wherein the relation represents that Susie may want the perfume. However, other kinds of item relation categories may be employed including that Kyle recommends the perfume for Susie, or that Kyle wishes to purchase the perfume for Susie and the like.

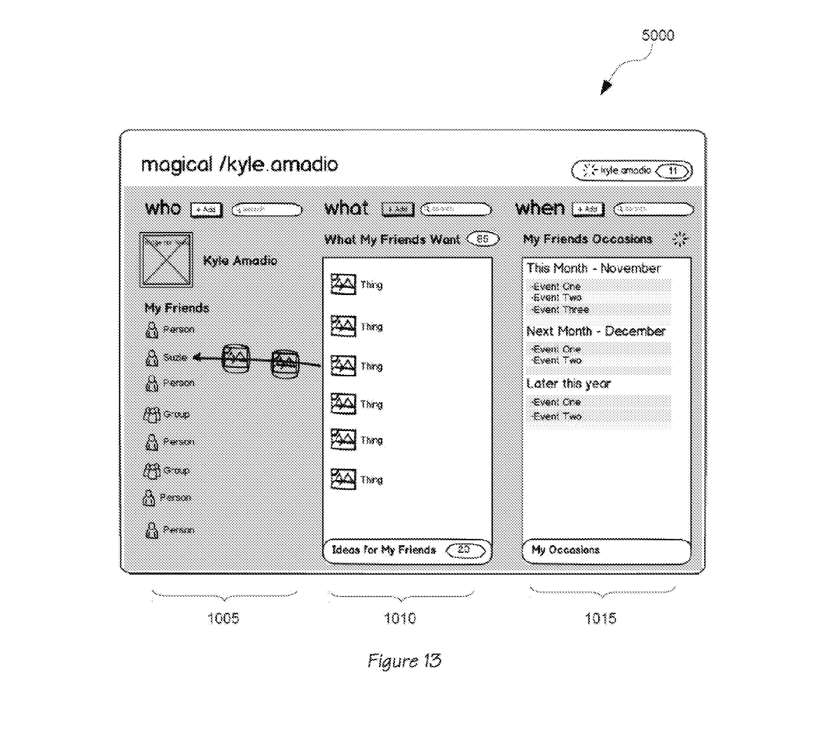

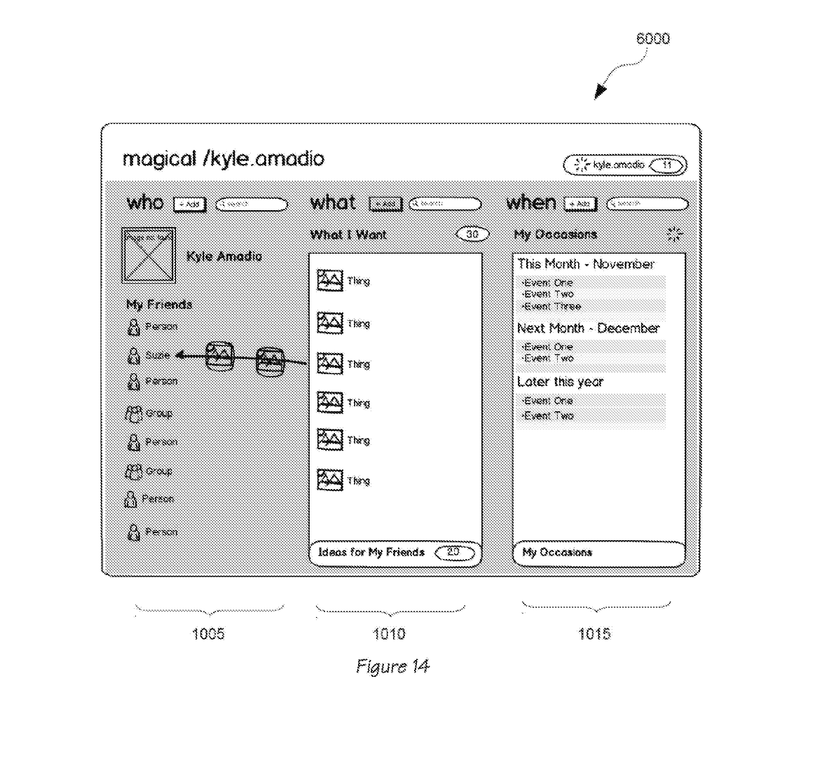

In a similar manner, wherein the interface 5000 shows the creation of item relations between items wanted by social relations of the user and social relations of the user, referring to FIG. 14, there is shown the exemplary graphical user interface 6000 wherein allowing the user to create relations between items associated with the user and social relations. In other words, the item region 1010 of interface 5000 shows those items wanted by Kyle's social relations wherein the item region 1010 of the interface 6000 represents those items wanted by Kyle himself.

### Product Fulfillment

Referring again to FIG. 1, the system 100 comprises at least one product fulfillment server 190. As alluded to above, the embodiments described herein may be utilised for the purposes of social e-commerce shopping. In this manner, having created associations between items and users of the social graph 300 the system 100 may be adapted for arranging for the fulfillment of such real-world items.

For example, should Kyle represent that Kyle wishes for a Toshiba laptop for his birthday, should his friend Jake wish to purchase the Toshiba laptop for Kyle's birthday, Jake may utilise the system 100 to do so. In this manner, Jake may make payment, such as by using credit card or the like using a payment facility provided by the system wherein, upon successful completion of such payment, the system 100 is adapted to send product order dated to a relevant product fulfillment server (such as a product fulfillment server belonging to Toshiba, Amazon or the like) so as to arrange for the dispatch of the Toshiba laptop to Kyle.

### Object Role Modelling

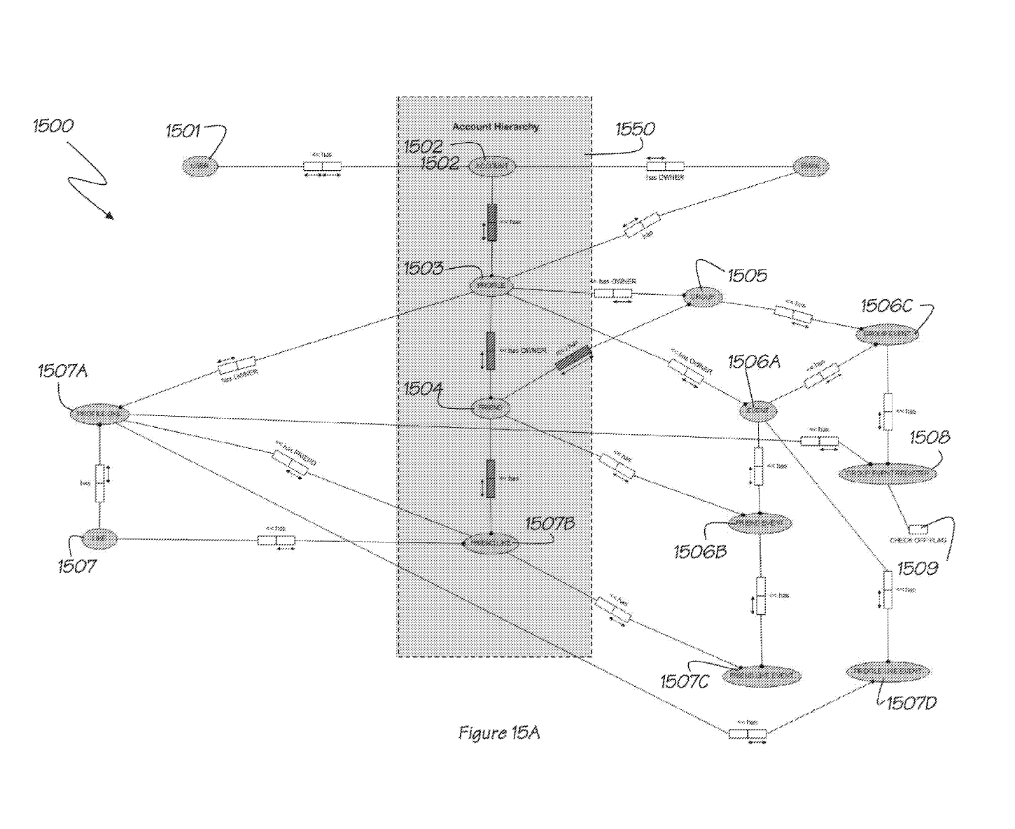

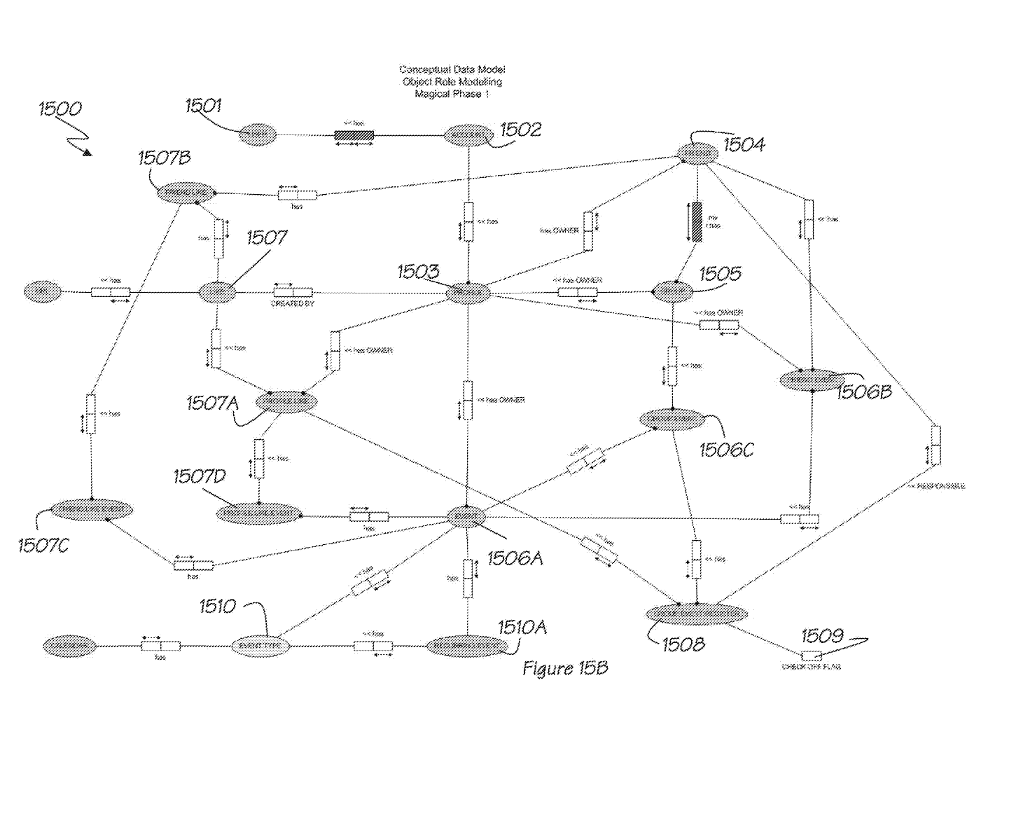

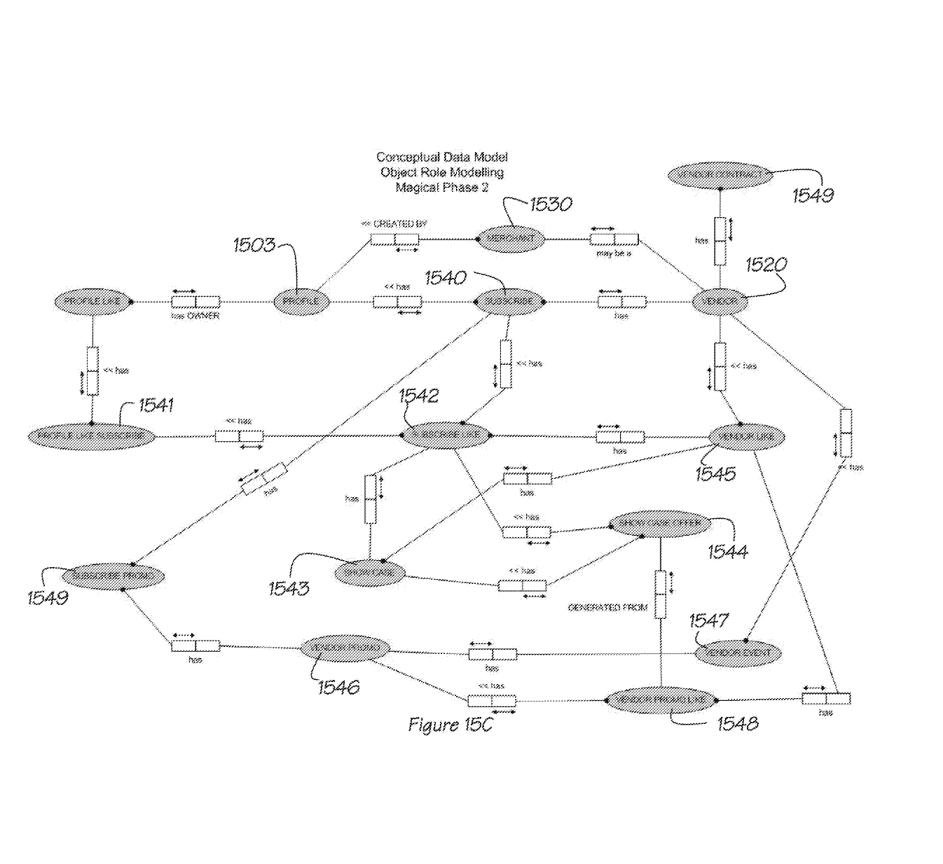

Referring now to FIG. 15A, there is depicted an object model representation 1500 of social graph 300 of FIG. 3A depicting the hierarchical elements 1550 associated with a User 1501. For instance, a User 1501 has an Account 1502 and an associated User Profile 1503. User 1501 has Friends 1504 and a plurality of Friends 1504 may be associated in a Group 1505 associated with users profile 1503. Each User 1501 may associate an Event 1506A with the User Profile 1503. Similarly, the user 1501 is associated with Friend Events 1506B further associated with any one of user's friends 1504. Furthermore, the user may associate a Group Event 1506C with an associated group 1505. As discussed above, the system provides the ability of users to “Like” 1507 a node of the social graph in order to subscribe or be alerted to changes or updates to the Liked node entity such as, as shown in FIG. 15A, “Profile Like” 1507A, “Friend Like” 1507 “Friend Like Event” 1507C, “Profile Like Event” 1507D. Also, as discussed above and depicted in the relationships shown in FIG. 15A, and Event such as a group event may be associated with a Group Event Register 1508 similar to a conventional wedding gift register however the register may include items from a variety of different merchants or vendors and is not limited to a single merchant or vendor. In the present system and as depicted in FIG. 15A each item in a group event register may be associated with a Check Off Flag 1509 that can be activated by a user when a particular item in the group event register is purchased to indicate that the item should be removed from the list and as such is not shown to further group members as a gift option for the group event.

FIG. 15B shows an alternate depiction of object role model/conceptual data model 1500 of social graph 300 further indicating associations between various User/Profile/Friend/Event nodes in the social graph and also depicting that each Event 1506A may be associated a specific Event Type 1510, such as for example a Recurring Event 1510A.

FIG. 15C depicts an object role model/conceptual data model 1600 of social graph 300 depicting the relationships and associations between users (specifically user profile nodes 1503) and vendor nodes 1520 and merchant nodes 1530 as discussed above to promote interaction between users and the vendors and merchants for association of items for sale by such vendors or merchants with the user's friends and/or events as discussed above. As can be seen in FIG. 15C, a user profile may subscribe to a particular vendor receives updates from that particular vendor with regard to products availability, special deals, or showcase offers or promotions. Similarly, a user can “Like” a vendor or a particular vendor promotion or Showcase Event/Offer in order to receive updates regarding the specific Liked node.

As can be seen from the above disclosure vertically from official data models of FIGS. 15A to 15C, the social interaction connection management system of social graph 300 provides users with a sophisticated method for associating items and events with their various friends on one or more social media platforms. In particular, the presently described systems and methods provide sophisticated capabilities for each user of the system to manage their social connections and similarly do away with many inefficient processes or managing and keeping track of all, for example, gifts for each of their social connections. Beyond simple management of gift ideas for social connections, there presently is consistent with very sophisticated methods for users to recommend or suggests various e.g. gifts for any of their social connections which can then be shared amongst their social network thus enabling far greater coordination between friends and associates say, for example, when coordinating gifts for a particular event, such as that that a birthday party, wedding, barbecue etc.

Merchant 1530 may become in time a Vendor 1520 which will then have a Vendor Contract 1549. Profile 1503 may Subscribe 1540 only to Vendor 1520 and may further refine the subscription using a Subscribe Like 1542 which is a relationship between Profile Like Subscribe 1541 and the Vendor Like 1545 e.g. the user may choose to Subscribe only to see Whiskey from Vendor Chambers Liquor. The vendor can display their vendor like 1545 in ShowCase 1543 for a Subscribe Like 1542. Also a vendor 1520 can have ShowCase offer 1544 of Vendor Promo Like 1548, for example, vendor Chamber Liquor may have a Christmas Promotion on Whiskey products. A profile 1503 may subscribe to promotions (Subscribe Promo 1549) to a specific Vendor Promo 1546 for a specific vendor event 1547, which will be Show Case Offer 1544, for example, user Emmanuel may subscribe to Chamber Liquor for any Christmas Promotions so that Emmanuel receives a notification for any promotions, offers or events by the particular vendor 1520.

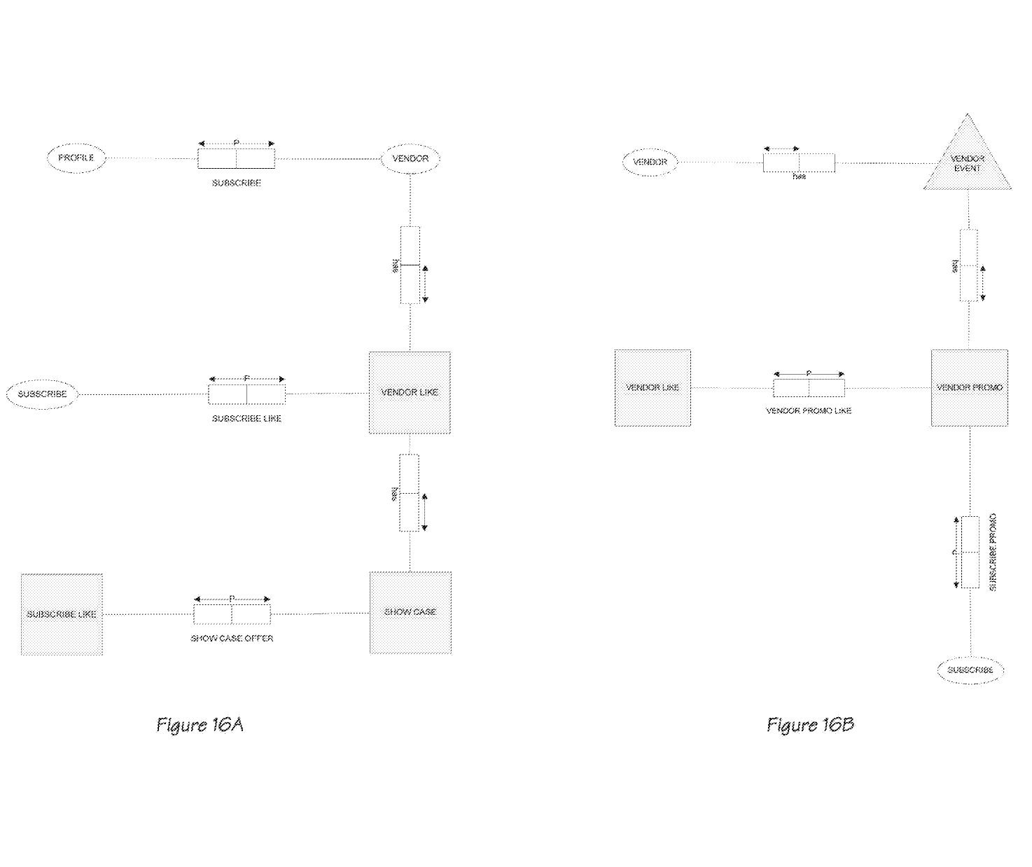

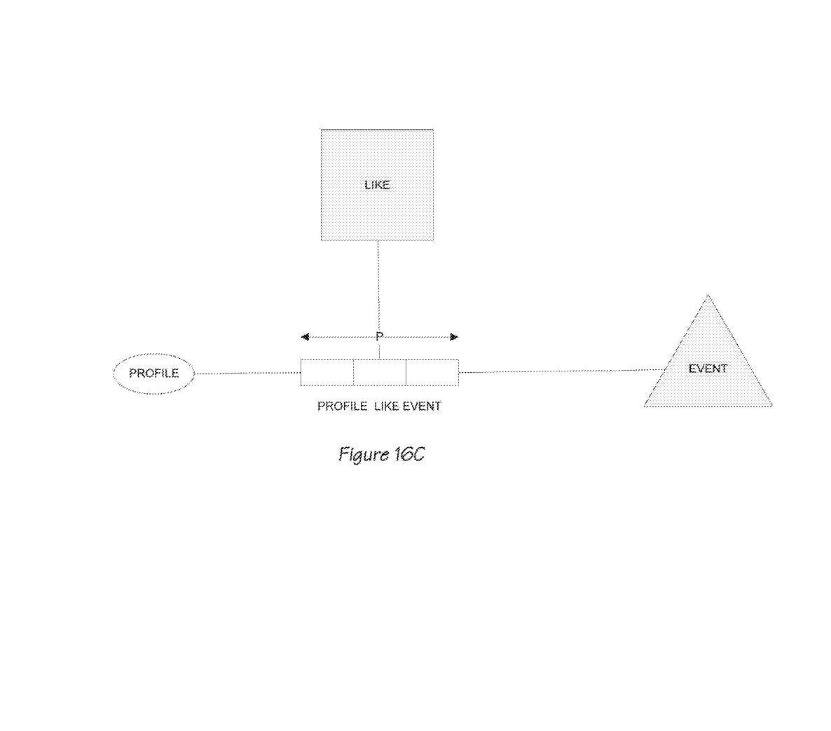

FIGS. 16A and 16B show detailed object role model depictions of the social graph nodes of FIGS. 15A to 15C and relationships for social interaction systems between a user (specifically a User Profile), a Vendor and Events, identifying the social relationships made available to a user of the presently disclosed system to interact with a preferred vendor through Vendor Likes, Subscriptions & Subscribe Likes and Vendor Show Cases or promotions, and Event Likes.

### Interpretation

### Social Graph

The term social graph as used herein is a data structure comprising one or more connections describing the relationships between individuals and the like and is defined explicitly by the one or more connections.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In Accordance with:

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activated by a license key downloaded from a computer network.

### Database:

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include SQL, NoSQL, XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments:

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limited to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments:

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognise that other and further modifications may be made thereto without departing from the spirit of the invention, and it is intended to claim all such changes and modifications which fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms. It will be appreciated that the methods/apparatus/devices/systems described/illustrated above at least substantially provide a computing device for relating nodes and items in social graph.

The computing devices, systems and methods described herein, and/or shown in the drawings, are presented by way of example only and are not limiting as to the scope of the invention. Unless otherwise specifically stated, individual aspects and components of the computing devices, systems and methods may be modified, or may have been substituted therefore known equivalents, or as yet unknown substitutes such as may be developed in the future or such as may be found to be acceptable substitutes in the future. The computing devices, systems and methods may also be modified for a variety of applications while remaining within the scope and spirit of the claimed invention, since the range of potential applications is great, and since it is intended that the present computing devices, systems and methods be adaptable to many such variations.

1. A computing device for relating nodes and items in a social graph, the computing device comprising:
a processor for processing digital data;
a memory device for storing digital data including computer program code, the memory device being in operable communication with the processor;
a display device for displaying digital data, the display device being in operable communication with the processor;
a user interface adapted for receiving user input data representing user input, the user interface being in operable communication with the processor and wherein, in use, the processor is controlled by the computer program code to:
display, using the display device, a graphical user interface, wherein the graphical user interface comprises:
a social node region representing at least one node of a social graph, said social graph comprising a plurality of nodes, each said node being representative of one or more of a person, a vendor of goods and/or services, organization, item, or an event; and
an item region representing at least one item, wherein the at least one item comprises a digital item created by a user, said user comprising a user account comprising multiple profiles, each said multiple profile being synonymous with a type of social media broadcaster;
receive, via the user interface, the item relation creation user input data representing an item relation creation user input; and
create a relationship between the at least one node and the at least one item in accordance with the item relation creation user input data.

2. A computing device as claimed in claim 1, wherein said user interface is adapted to form an association between a profile associated with the user account and a merchant or vendor.

3. A computing device as claimed in claim 2 wherein said an association between a profile associated with the user account and a merchant or vendor comprises:
an association between a profile associated with the user account and a product or promotion associated with said merchant or vendor at a selected hierarchical level.

4. A computing device as claimed in claim 3 wherein said user interface is adapted to display promotions from each said merchant or vendor to which said profile is subscribed.

5. A computing device as claimed in claim 2, wherein said merchant is adapted to comprise a vendor on satisfaction of a vendor contract.

6. A computing device as claimed in claim 2, wherein said user interface is adapted to provide specifically tailored promotions to subscribed user profiles from subscribed vendors.

7. A computing device as claimed in claim 1, wherein the digital item comprises a photograph.

8. A computing device as claimed in claim 1, wherein the user input data represents the association of the at least one node with the at least one item.

9. A computing device as claimed in claim 1, wherein the item relation creation user input comprises a drag and drop gesture having a source coinciding with a display location of the at least one node and a target coinciding substantially with a display location of the at least one item.

10. A computing device as claimed in claim 1, wherein the user input data represents the association of the at least one item with the at least one node.

11. A computing device as claimed in claim 10, wherein the item relation creation user input comprises a drag and drop gesture having a source coinciding with a display location of the at least one item and a target coinciding substantially with a display location of the at least one node.

12. A computing device as claimed in claim 1, wherein the graphical user Interface further comprises:
an event region representing at least one event, and wherein, in use, the processor is controlled by the computer program code to:
receive, via the user interface, event relation creation user input data; and
create a relationship between the at least one item and the at least one event.

13. A computing device as claimed in claim 12, wherein the user input data represents the association of the at least one item with the at least one event.

14. A computing device as claimed in claim 13, wherein the item relation creation user input comprises a drag and drop gesture having a source coinciding with a display location of the at least one item and a target coinciding substantially with a display location of the at least one event.

15. A computing device as claimed in claim 12, wherein the user input data represents the association of the at least one event with the at least one item.

16. A computing device as claimed in claim 15, wherein the item relation creation user input comprises a drag and drop gesture having a source coinciding with a display location of the at least one event and a target coinciding substantially with a display location of the at least one item.

17. A computing device as claimed in claim 1, wherein creating the relationship comprises causing the update of social graph data.

18. A computing device as claimed in claim 17, further comprising a network interface adapted for sending and receiving data across a data network, the network interface being in operable communication with the processor and wherein, in use, the processor is further controlled by the computer program code to:
send, via the network interface to a social graph server, social graph update data representing the relationship.

19. A computing device as claimed in claim 1, wherein the at least one node represents a friend node selected in accordance with at least one social relationship within a social graph.

20. A computing device as claimed in claim 19, wherein the at least one node comprises at least two nodes comprising a first node representing a user node within the social graph and the friend node.

21. A computing device as claimed in claim 1, wherein the at least one item is selected in accordance with at least one social relationship within a social graph.

22. A computing device as claimed in claim 1, wherein the at least one event is selected in accordance with at least one social relationship within a social graph.

23. (canceled)

24. A computing device as claimed in claim 1, wherein the user interface is overlaid on the display device.

25. A computing device as claimed in claim 1, wherein the social graph is integrated with one or more social media platforms controlled by a user wherein nodes of the social graph are derived from the user's social connections within the one or more social media platforms.

26. (canceled)

27. A computing device as claimed in claim 1, wherein a user of the system may be a vendor of good and/or services and wherein the vendor user is capable of promoting said goods or services via one or more nodes of the social graph.

28. (canceled)
